(19) United States
(12) Patent Application Publication
(10) Pub. No.: US 2023/0408308 A1
(43) Pub. Date: Dec. 21, 2023

(54) WEARABLE DEVICE AND CONTROL METHOD THEREOF

(71) Applicant: SONY GROUP CORPORATION, Tokyo (JP)

(72) Inventor: Kimihiro FUKUI, Tokyo (JP)

(73) Assignee: SONY GROUP CORPORATION, Tokyo (JP)

(21) Appl. No.: 18/245,432

(22) PCT Filed: Aug. 6, 2021
(86) PCT No.: PCT/JP2021/029253

§ 371 Date: Mar. 15, 2023

(30) Foreign Application Priority Data
Oct. 1, 2020 (JP) 2020-167091

(51) Int. Cl. G01D 21/02; H04R 1/10

(52) U.S. Cl. CPC G01D 21/02; H04R 1/1016; H04R 1/1041; G06F 3/011

(57) ABSTRACT

To provide a wearable device that detects a state of being worn on a body of a user. A wearable device includes: a main body; a first proximity sensor disposed on a first side surface of the main body; a second proximity sensor disposed on a second side surface of the main body, the second side surface forming an angle equal to or larger than a predetermined angle with the first side surface; and a determination unit that determines whether or not the main body is worn on a body of a user on the basis of a sensor signal of each of the first proximity sensor and the second proximity sensor. When the main body is worn on an ear of the user, the first side surface faces a cavum concha, and the second side surface faces an antitragus or an antihelix.

### TECHNICAL FIELD

The technology disclosed in the present description (hereinafter, referred to as “the present disclosure”) relates to a wearable device used by being worn on a body of a user and to a control method of the wearable device.

### BACKGROUND ART

Recently, a terminal that can be used while being worn by a user, that is, a wearable device are becoming commonly available. There are various forms of wearable devices such as glasses, earphones, necklaces, watches, belts, and shoes. Many wearable devices are battery-driven, and are controlled to stop operation and save battery consumption according to a wearing state.

For example, an earphone having a wearing detection function plays music in a worn state, temporarily stops the music when being temporarily removed from the ear, and automatically plays the music when being worn on the ear again. Furthermore, when a predetermined time elapses after the earphone is removed from the ear, the power of the earphone can be automatically turned off to prevent battery consumption.

For example, an earphone that detects a worn state using a proximity sensor such as an infrared sensor is known (see Patent Document 1). However, there is a possibility that a finger removing the earphone touches the proximity sensor, or the finger of the user or another object approaches the proximity sensor of the earphone in a non-worn state to cause the wearable device to be erroneously detected to be in the worn state. If the earphone malfunctions due to the erroneous detection and continues to play music, the earphone generates noise to the surrounding and a battery is wasted.

### CITATION LIST

### Patent Document

Patent Document 1: International Patent Application No. WO 2015/110587

### SUMMARY OF THE INVENTION

### Problems to be Solved by the Invention

An object of the present disclosure is to provide a wearable device that detects a state of being worn on a body of a user, and a control method of the wearable device.

### Solution to Problems

The present disclosure has been made in view of the above problems, and a first aspect thereof is a wearable device including:
a main body;
a first proximity sensor disposed on a first side surface of the main body;
a second proximity sensor disposed on a second side surface of the main body, the second side surface forming an angle equal to or larger than a predetermined angle with the first side surface; and
a determination unit that determines whether or not the main body is worn on a body of a user on the basis of a sensor signal of each of the first proximity sensor and the second proximity sensor.

The wearable device according to the first aspect is configured such that when the main body is worn on an ear of the user, the first side surface faces a cavum concha, and the second side surface faces an antitragus or an antihelix.

The wearable device according to the first aspect further includes a control unit that controls the main body on the basis of a determination result by the determination unit.

Furthermore, a second aspect of the present disclosure
is a control method of a wearable device used by being worn on a body of a user,
the wearable device including a main body, a first proximity sensor disposed on a first side surface of the main body, and a second proximity sensor disposed on a second side surface of the main body, the second side surface forming an angle equal to or larger than a predetermined angle with the first side surface,
the control method including:
a determination step of determining whether or not the main body is worn on the body of the user on the basis of a sensor signal of each of the first proximity sensor and the second proximity sensor; and
a control step of controlling the main body on the basis of a determination result in the determination step.

### Effects of the Invention

According to the present disclosure, it is possible to provide a wearable device that accurately detects a state of being worn on a body of a user such as an ear, by combining a plurality of detection units.

Note that the effects described in the present description are merely examples, and the effects brought by the present disclosure are not limited thereto. Furthermore, there is a case where the present disclosure further provides additional effects in addition to the above effects.

Still other objects, features, and advantages of the present disclosure will become apparent from a more detailed description based on an embodiment to be described later and the accompanying drawings.

### BRIEF DESCRIPTION OF DRAWINGS

FIG. 1 is a view showing an external configuration of an earphone 100.

FIG. 2 is a view showing a state in which the earphone 100 is worn on an ear of a user.

FIG. 3 is a view showing a cross section of the earphone 100 worn on the ear of the user.

FIG. 4 is a view showing a state in which the user grips two facing side surfaces of a main body 101 of the earphone 100 using two fingers which are an index finger and a thumb.

FIG. 5 is a view showing a state in which the user grips two facing side surfaces of the main body 101 of the earphone 100 using two fingers which are the index finger and the thumb.

FIG. 6 is a diagram showing an internal configuration example of the earphone 100.

FIG. 7 is a view showing an external configuration example of a head mounted display 700.

FIG. 8 is a view showing a wearing detection function of the head mounted display 700.

FIG. 9 is a diagram showing an internal configuration example of the head mounted display 700.

FIG. 10 is a view showing a wearable device 1000.

FIG. 11 is a view showing a state of the wearable device 1000 being gripped.

FIG. 12 is a view showing a wearable device 1200.

FIG. 13 is a view showing a state of the wearable device 1200 being gripped.

FIG. 14 is a view showing a wearable device 1400.

FIG. 15 is a view showing a state of the wearable device 1400 being gripped.

### MODE FOR CARRYING OUT THE INVENTION

Hereinafter, the present disclosure is described with reference to the drawings in the following order.
A. Overview
B. Example applied to earphone
   B-1. External configuration
   B-2. Operation example
   B-3. Internal configuration example
C. Example applied to head mounted display
   C-1. External configuration
   C-2. Configuration example of detection unit
   C-3. Internal configuration example

### A. Overview

By mounting the wearing detection function on the wearable device, control according to the wearing state can be performed. For example, the operation can be stopped at the time of not wearing the wearable device to save battery consumption. In addition, in a wearable device of a type that outputs a reproduction signal of content such as an earphone or a head mounted display, when the state of not wearing the wearing device is detected, reproduction is temporarily stopped, and when a state of wearing the wearable device is detected again, reproduction can be automatically started.

However, when the state of the wearable device being worn or not is erroneously determined, there is a problem that the operation of the wearable device cannot be appropriately controlled. For example, there is a possibility that the wearable device is erroneously detected to be in the worn state by the user holding a device body with a fingertip in order to remove the wearable device.

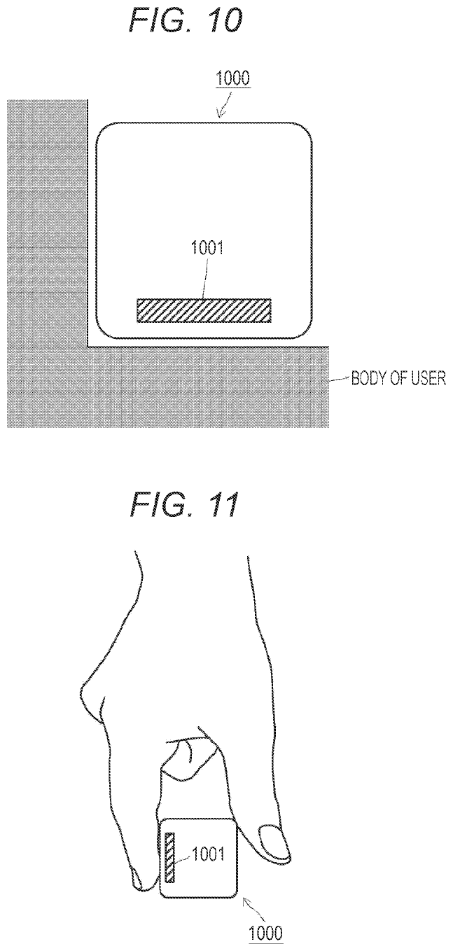

For example, as shown in FIG. 10, in a case where a wearable device 1000 worn in contact with or in proximity to the body of the user on two or more side surfaces, the wearable device can be detected to be worn on the body of the user by disposing a sensor 1001 for detecting the worn state on one of the side surfaces. However, as shown in FIG. 11, in order to remove the wearable device 1000 from the body of the user or perform other operations, there is a possibility that the fingertip (the index finger in the example shown in FIG. 11) holding the main body of the wearable device 1000 comes into contact with or approaches the sensor 1001 and erroneously detects the worn state.

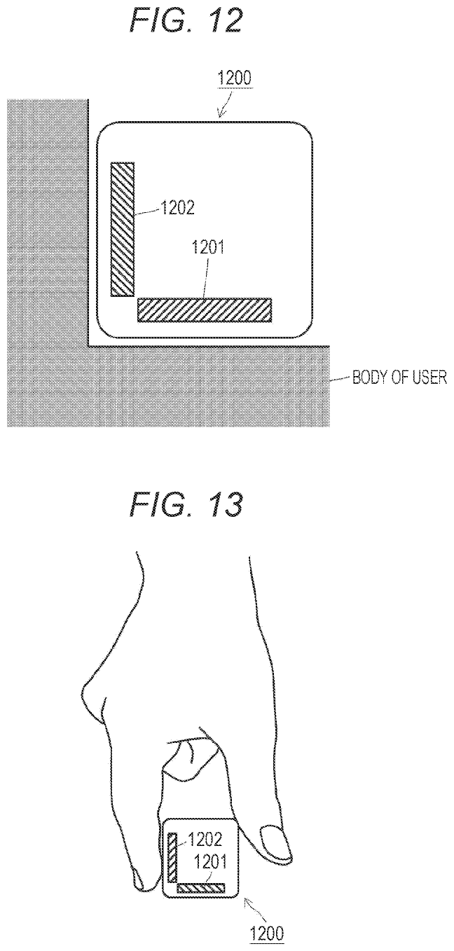

Therefore, in the present disclosure, for example, in a wearable device 1200 worn in contact with or in proximity to the body of the user on two or more side surfaces as shown in FIG. 12, a first proximity sensor 1201 is disposed on a first side surface, and meanwhile, a second proximity sensor 1202 is disposed on a second side surface different from the first side surface, and as shown in FIG. 12, only in a case where the first proximity sensor 1201 and the second proximity sensor 1202 simultaneously detect the contact or the proximity, and only in a case where the first proximity sensor 1201 and the second proximity sensor 1202 simultaneously detect the contact or the proximity, the wearable device is determined to be in the worn state and the wearable device is determined to be in the worn state. Furthermore, as shown in FIG. 13, even if the fingertip holding the main body of the wearable device 1200 comes into contact with or approaches the first proximity sensor 1201 in order to remove the wearable device 1200 from the body of the user or perform other operations, the second proximity sensor 1202 is separated from any fingertip of the user and thus does not detect the contact or the proximity, and thus the wearable device can be correctly determined to be in the non-worn state.

Here, the second side surface on which the second proximity sensor 1202 is disposed desirably forms a predetermined angle or more (for example, 90 degrees) with the first side surface on which the first proximity sensor 1201 is disposed.

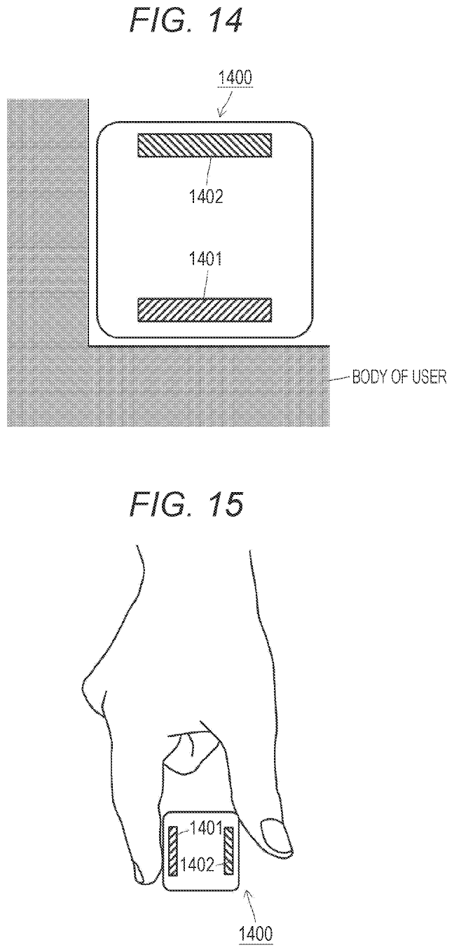

For example, in a wearable device 1400 worn in contact with or in proximity to the body of the user on two or more side surfaces as shown in FIG. 14, a case is considered in which a first proximity sensor 1401 is disposed on a first side surface and a second proximity sensor 1402 is disposed on a second side surface facing the first side surface. In the example shown in FIG. 14, the first side surface and the second side surface facing the first side surface are substantially parallel to each other, and the angle formed by these two surfaces is 0 degrees.

Even when the wearable device 1400 is worn on the body of the user, there are often cases where the first proximity sensor 1401 and the second proximity sensor 1402 do not simultaneously detect the contact or the proximity. Furthermore, as shown in FIG. 15, in order to remove the wearable device 1400 from the body of the user or perform other operations, there is a possibility that the main body of the wearable device 1200 is held with the fingertips on the first side surface and the second side surface to cause the first proximity sensor 1401 and the second proximity sensor 1402 to erroneously detect the worn state simultaneously.

Therefore, as shown in FIG. 12, by disposing the second proximity sensor 1202 on the second side surface forming an angle equal to or larger than a predetermined angle (for example, 90 degrees) with respect to the first side surface on which the first proximity sensor 1201 is disposed, the worn state can be accurately determined when the wearable device 1200 is worn on the body of the user, and the non-worn state can be accurately determined when the wearable device 1200 is removed from the body of the user.

### B. Example Applied to Earphone

### B-1. External Configuration

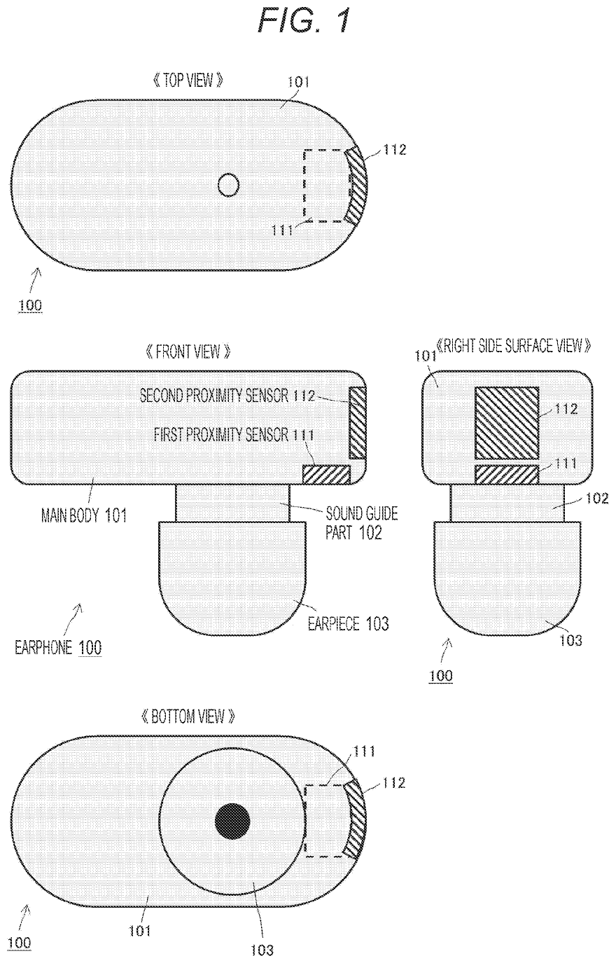

FIG. 1 shows an external configuration of an earphone 100 to which the present disclosure is applied. Specifically, FIG. 1 shows a front view, a right side view, a top view, and a bottom view. The earphone 100 includes a main body 101, a sound guide part 102, and an earpiece 103.

The main body 101 incorporates main components such as a wireless communication unit that transmits and receives a wireless signal such as an audio reproduction signal to and from an external device, a signal processing unit that processes an audio reproduction signal, and an acoustic element. The sound guide part 102 is a hollow tubular component including a sound conduit that transmits sound generated by the acoustic element. The earpiece 103 is a buffer body attached to the distal end of the sound guide part 102 and attached to the vicinity of an entrance of the ear canal at the time of using the earphone 100. The earpiece 103 has, for example, an umbrella shape so as to conform to the shape near the entrance of the ear canal, and includes, for example, an elastic body such as rubber.

The present disclosure is characterized in that a first proximity sensor 111 is disposed on the bottom surface as the first side surface of the main body 101, and a second proximity sensor 112 is disposed on the right side surface as the second side surface of the main body 101. The bottom surface and the right side surface of the main body 101 form an angle of approximately 90 degrees. Therefore, a direction in which the first proximity sensor 111 is to be detected and a direction in which the second proximity sensor 112 is to be detected form an angle of approximately 90 degrees.

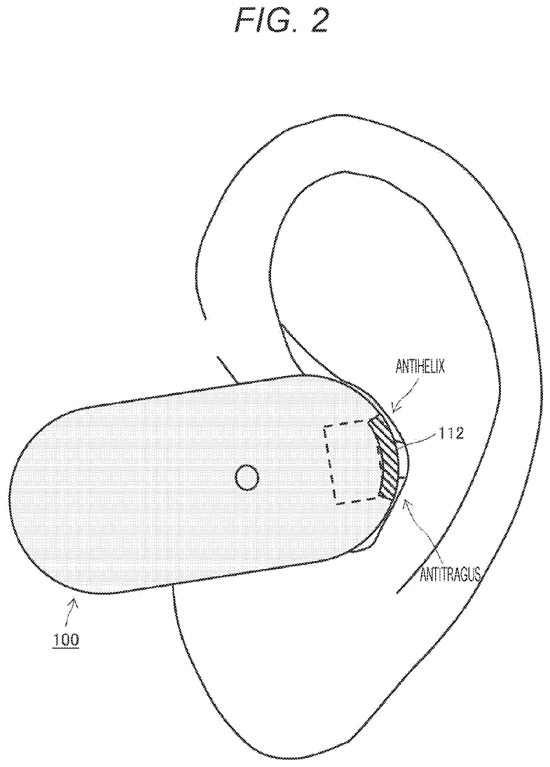

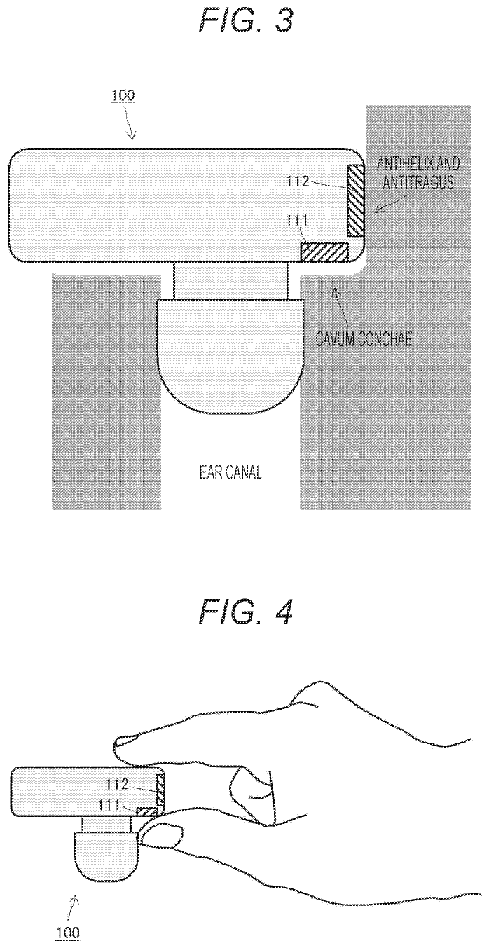

FIG. 2 is a view showing a state in which the earphone 100 is worn on an ear of a user. Furthermore, FIG. 3 is a view showing a cross section of the earphone 100 worn on the ear of the user. In a state where the earphone 100 shown in FIGS. 2 and 3 is worn on the ear of the user, the bottom surface of the main body 101 approaches a cavum concha. Therefore, the first proximity sensor 111 disposed on the bottom surface of the main body 101 can capture the cavum concha and detect that the earphone 100 is worn on the ear. Meanwhile, the right side surface of the main body 101 abuts on the antitragus and the antihelix. Therefore, the second proximity sensor 112 disposed on the right side surface of the main body 101 can capture at least one of the antitragus or the antihelix and detect that the earphone 100 is worn on the ear.

Therefore, by the first proximity sensor 111 and the second proximity sensor 112 simultaneously detecting the contact or the proximity, the earphone 100 can be determined to be in the worn state.

In order to detect the worn state of the earphone 100 as shown in FIGS. 2 and 3, only the detection result of either the first proximity sensor 111 or the second proximity sensor 112 is required. However, in a case where only one of the first proximity sensor 111 and the second proximity sensor 112 is used, there is a possibility that the earphone is erroneously detected to be in the worn state by the user holding the main body 101 with the fingertip in order to remove the earphone 100 from the ear. On the other hand, in the present disclosure, the first proximity sensor 111 and the second proximity sensor 112, which are respectively disposed on the bottom surface and the right side surface of the main body 101 forming an angle of approximately 90 degrees, are used in combination to prevent erroneous determination of the worn state.

Here, the first proximity sensor 111 includes, for example, an IR sensor, but includes any of an electrostatic sensor, a body temperature sensor, and a color sensor, or a combination of the IR sensor and any of the electrostatic sensor, the body temperature sensor, and the color sensor. The body temperature sensor detects the temperature of human skin. Furthermore, the color sensor detects skin color. Referring to FIG. 3, during a period of the earphone 100 being worn on the ear of the user, the bottom surface of the main body 101 is not always in contact with the cavum concha, and it is also assumed that a gap is present. Therefore, a non-contact proximity sensor such as an IR sensor or a color sensor is preferably used as the first proximity sensor 111 instead of a contact sensor such as an electrostatic sensor.

Furthermore, the second proximity sensor 112 includes, for example, an IR sensor, but includes any of an electrostatic sensor, a body temperature sensor, and a color sensor, or a combination of the IR sensor and any of the electrostatic sensor, the body temperature sensor, and the color sensor. Referring to FIG. 3, during the period of the earphone 100 being worn on the ear of the user, the right side surface of the main body 101 is always in contact with the antihelix or the antitragus. Therefore, as the second proximity sensor 112, a contact sensor such as an electrostatic sensor may be used so that an incomplete worn state in which the right side surface of the main body 101 is not in contact with the antihelix or the antitragus can be determined as the non-worn state.

### B-2. Operation Example

In the present disclosure, because the worn state of the earphone 100 is determined by simultaneously detecting the contact or the proximity between the first proximity sensor 111 and the second proximity sensor 112, the erroneous determination can be avoided even when the user performs various operations on the earphone 100.

FIG. 4 is a view showing a state in which the user grips the upper surface and the bottom surface of the main body 101 of the earphone 100, the upper and bottom surface facing each other, using two fingers which are the index finger and the thumb. In the example shown in FIG. 4, the thumb comes into contact with or approaches the bottom surface of the main body 101 and the first proximity sensor 111 detects a state of the contact or the proximity. Meanwhile, the index finger comes into contact with the upper surface of the main body 101 but is separated from the second proximity sensor 112, and thus, does not detect the state of the contact or the proximity. Therefore, in the grasping operation as shown in FIG. 4, because only one of the first proximity sensor 111 and the second proximity sensor 112 detects the contact or the proximity, the earphone 100 can be accurately determined to be in the non-worn state.

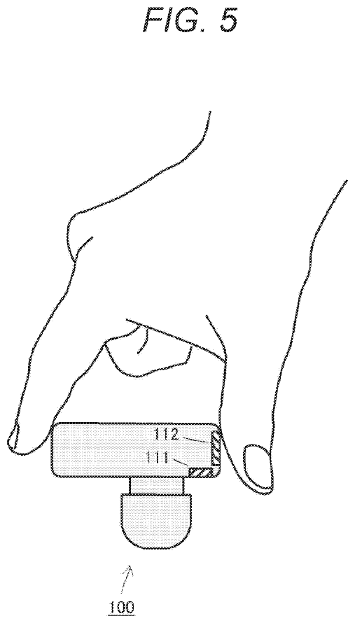

FIG. 5 is a view showing a state in which the user grips the right side surface and the left side surface of the main body 101 of the earphone 100, the right and left side surfaces facing each other, using two fingers which are the index finger and the thumb. In the example shown in FIG. 5, the thumb comes into contact with or approaches the right side surface of the main body 101 and the second proximity sensor 112 detects a state of the contact or the proximity. Meanwhile, the index finger comes into contact with the left side surface of the main body 101 but is separated from the first proximity sensor 111, and thus, does not detect the state of the contact or the proximity. Therefore, also in the grasping operation as shown in FIG. 5, because only one of the first proximity sensor 111 and the second proximity sensor 112 detects the contact or the proximity, the earphone 100 can be accurately determined to be in the non-worn state.

Needless to say, even when the earphone 100 is packed in a carrying bag or the like, there is no possibility that the worn state is erroneously determined.

### B-3. Internal Configuration Example

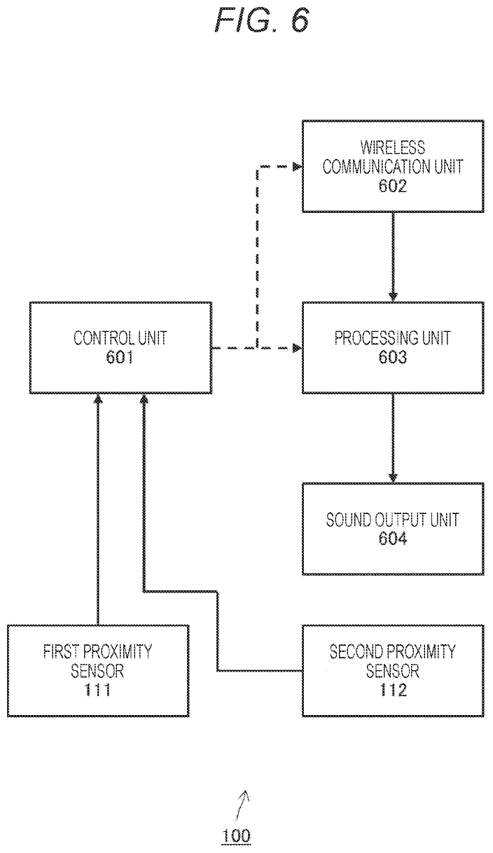

FIG. 6 shows an internal configuration example of the earphone 100. Each constitutional element shown in FIG. 6 is basically incorporated in the main body 101, but naturally, at least a part thereof may be disposed outside the main body 101. In the illustrated example, the earphone 100 includes a control unit 601, a wireless communication unit 602, a processing unit 603, and a sound output unit 604. Note that, in each constitutional element disposed in the main body of the earphone 100, for example, each constitutional element in the main body 101 is driven by a battery, but in FIG. 6, illustration of a power supply mode is omitted for simplification of the drawing.

The control unit 601 comprehensively controls operation in the earphone 100. The wireless communication unit 602 wirelessly communicates with an external device in accordance with a communication standard such as the Bluetooth (registered trademark) Low Energy (BLE), for example, to exchange an audio reproduction signal and other control signals. The external device referred to herein is, for example, an information terminal (none of which is illustrated) serving as a sound source, such as a smartphone, a tablet, a personal computer, or a portable music player.

The processing unit 603 performs signal processing on the audio reproduction signal received via the wireless communication unit 602 under the control of the control unit 601. The signal processing may include resolution conversion (resolution enhancement), noise cancellation, noise reduction, and the like in addition to volume and sound quality adjustment. Although constitutional elements other than those illustrated in FIG. 6 may be further included for the noise cancellation and the noise reduction, the constitutional elements are not directly related to the present disclosure, and thus illustration and detailed description thereof are omitted.

The sound output unit 604 outputs audio on the basis of the audio reproduction signal processed by the processing unit 603. The sound output unit 604 may be a speaker of any one of a dynamic type, a balanced armature type, a capacitor type, a piezoelectric type, and an electrostatic type, or a combination of two or more types.

Furthermore, the first proximity sensor 111 includes, for example, an IR sensor, but includes any of an electrostatic sensor, a body temperature sensor, and a color sensor, or a combination of the IR sensor and any of the electrostatic sensor, the body temperature sensor, and the color sensor. Furthermore, the second proximity sensor 112 includes, for example, an IR sensor, but includes any of an electrostatic sensor, a body temperature sensor, and a color sensor, or a combination of the IR sensor and any of the electrostatic sensor, the body temperature sensor, and the color sensor.

The control unit 601 determines that the earphone 100 is in the worn state only in a case where the first proximity sensor 111 and the second proximity sensor 112 simultaneously detect the contact or the proximity to prevent the erroneous determination during operation of, for example, removing the earphone 100 from the ear.

Furthermore, the control unit 601 controls the audio output on the basis of the determination result of the worn state based on the detection results of the first proximity sensor 111 and the second proximity sensor 112. For example, the control unit 601 plays music when the earphone 100 is in the worn state, temporarily stops the music when the earphone 100 is temporarily removed from the ear, and automatically plays the music when the earphone 100 is worn on the ear again. Furthermore, when a predetermined time elapses after the earphone 100 is removed from the ear, the control unit 601 may automatically turn off the power of the earphone 100 to prevent battery consumption.

### C. Example Applied to Head Mounted Display

### C-1. External Configuration

The head mounted display is a display device worn on the head of the user. A transmission system of the head mounted display can be roughly classified into a non-transmission system and a transmission system, and the transmission system can be further classified into an optical see-through system and a video see-through system. In addition, the head mounted display may have an audio output function in addition to a video display function, and may further have a biological information detection function or other functions.

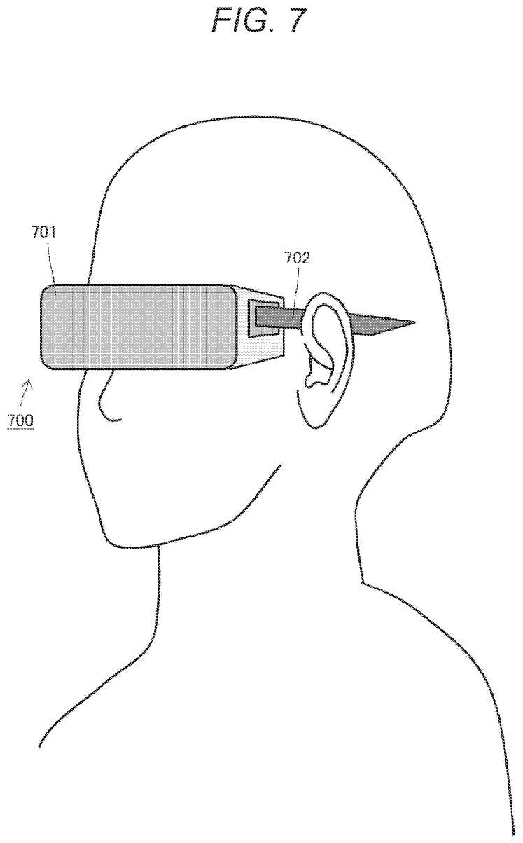

FIG. 7 shows a state in which a head mounted display 700 is worn on the head of the user. The illustrated head mounted display 700 includes a main body 701 and a temple 702 that supports the main body 701 with an auricle. Although the temples 702 are attached symmetrically, one on each of the left and right sides of the main body 701, only the left-side temple 702 is illustrated in FIG. 7, and the right-side temple is hidden by the head of the user and cannot be seen.

### C-2. Configuration Example of Detection Unit

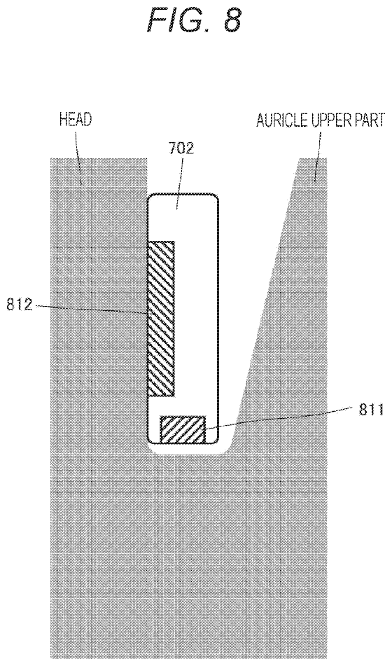

The temple 702 is provided with a wearing detection function in the vicinity of a base between the upper part of the auricle and the head. FIG. 8 shows a cross-sectional configuration example of the temple 702 at a portion where the wearing detection function is provided. As shown in FIG. 8, a first proximity sensor 811 is disposed at the bottom of the temple 702, and a second proximity sensor 812 is disposed at the side of the temple 702.

In a state where the head mounted display 700 is worn on the head of the user, the bottom of the temple 702 is close to the valley at the base between the upper part of the auricle and the head. Therefore, the first proximity sensor 811 disposed at the bottom of the temple 702 can capture the valley at the base between the upper part of the auricle and the head and detect that the head mounted display 700 is worn on the head. On the other hand, the side of the temple 702 abuts on the temporal region. Therefore, the second proximity sensor 812 disposed at the side of the temple 702 can capture the temporal region and detect that the head mounted display 700 is worn on the head.

Therefore, by the first proximity sensor 811 and the second proximity sensor 812 simultaneously detecting the contact or the proximity, the head mounted display 700 can be determined to be in the worn state. In addition, from the fact that the bottom and the side of the temple 702 form an angle of approximately 90 degrees, it is configured that, by using the first proximity sensor 811 and the second proximity sensor 812 in combination, erroneous determination of the worn state is prevented.

Here, the first proximity sensor 811 includes, for example, an IR sensor, but includes any of an electrostatic sensor, a body temperature sensor, and a color sensor, or a combination of the IR sensor and any of the electrostatic sensor, the body temperature sensor, and the color sensor. The body temperature sensor detects the temperature of human skin. Furthermore, the color sensor detects skin color. Referring to FIG. 8, during a period in which the head mounted display 700 is worn on the head of the user, the bottom of the temple 702 is not always in contact with the valley at the base between the upper part of the auricle and the head, and it is also assumed that a gap exists. Therefore, a non-contact proximity sensor such as an IR sensor or a color sensor is preferably used as the first proximity sensor 811 instead of a contact sensor such as an electrostatic sensor.

Furthermore, the second proximity sensor 112 includes, for example, an IR sensor, but includes any of an electrostatic sensor, a body temperature sensor, and a color sensor, or a combination of the IR sensor and any of the electrostatic sensor, the body temperature sensor, and the color sensor. Referring to FIG. 8, during the period in which the head mounted display 700 is worn on the head of the user, the side of the temple 702 is always in contact with the temporal region. Therefore, as the second proximity sensor 812, a contact sensor such as an electrostatic sensor may be used so that an incomplete worn state in which the side of the temple 702 is not in contact with the temporal region can be determined as the non-worn state.

### C-3. Internal Configuration Example

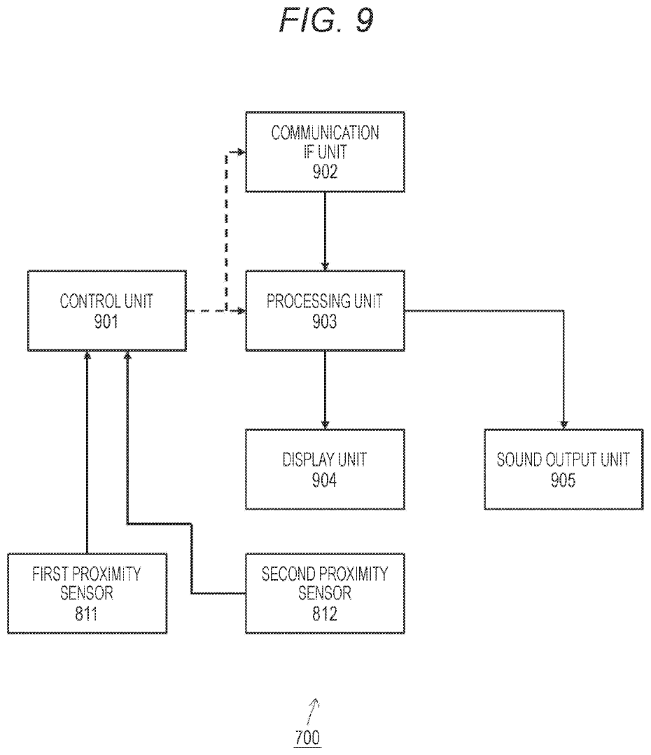

FIG. 9 is a diagram showing an internal configuration example of the head mounted display 700. Each constitutional element shown in FIG. 9 is basically built in the main body 701, but as shown in FIG. 8, the first proximity sensor 811 and the second proximity sensor 812 are disposed in the temple 702. In the illustrated example, the head mounted display 700 includes a control unit 901, a communication interface (IF) unit 902, a processing unit 903, a display unit 904, and a sound output unit 905.

The control unit 901 comprehensively controls operation in the head mounted display 700. The communication interface unit 902 communicates with an external device by using wired communication using a high definition multimedia interface (HDMI (registered trademark)), a universal serial bus (USB), or the like, or wireless communication such as Wi-Fi (registered trademark), and exchanges an audio visual (AV) signal and a control signal. The external device referred to herein is, for example, an information terminal (none of which is illustrated) serving as an AV source, such as a smartphone, a tablet, a personal computer, or a blu-ray disc player.

The processing unit 903 processes the AV signal received via the communication interface unit 902 under the control of the control unit 901. The signal processing may include resolution conversion (resolution enhancement), noise cancellation, noise reduction, and the like in addition to luminance conversion and resolution conversion of the video signal and volume and sound quality adjustment of the audio signal.

The display unit 904 displays and outputs the video signal processed by the processing unit 903. The display unit 904 includes, for example, a display device such as an organic light emitting diode (OLED) or a projection device such as virtual image projection or retinal projection. The sound output unit 905 outputs audio on the basis of the audio reproduction signal processed by the processing unit 903. The sound output unit 905 may be a speaker of any one of a dynamic type, a balanced armature type, a capacitor type, a piezoelectric type, and an electrostatic type, or a combination of two or more types.

The first proximity sensor 811 includes, for example, an IR sensor, but includes any of an electrostatic sensor, a body temperature sensor, and a color sensor, or a combination of the IR sensor and any of the electrostatic sensor, the body temperature sensor, and the color sensor. Furthermore, the second proximity sensor 812 includes, for example, an IR sensor, but includes any of an electrostatic sensor, a body temperature sensor, and a color sensor, or a combination of the IR sensor and any of the electrostatic sensor, the body temperature sensor, and the color sensor.

The control unit 901 determines that the head mounted display 700 is in the worn state only in a case where the first proximity sensor 811 and the second proximity sensor 812 simultaneously detect the contact or the proximity to prevent the erroneous determination during operation of, for example, removing the head mounted display 700 from the head.

Furthermore, the control unit 901 controls the AV content output on the basis of the determination result of the worn state based on the detection results of the first proximity sensor 811 and the second proximity sensor 812. For example, the control unit 901 reproduces the AV content in the worn state of the head mounted display 700, temporarily stops the reproduction of the AV content when the head mounted display 700 is temporarily removed from the head, and automatically restarts the reproduction of the AV content when the head mounted display 700 is mounted on the head again. Furthermore, when a predetermined time elapses after the head mounted display 700 is removed from the head, the control unit 901 may automatically turn off the power of the head mounted display 700 to prevent battery consumption.

### INDUSTRIAL APPLICABILITY

The present disclosure has been described in detail above with reference to specific embodiments. However, it is obvious that those skilled in the art can make modifications and substitutions of the embodiments without departing from the gist of the present disclosure.

Although the embodiment in which the present disclosure is applied to the earphone has been mainly described in the present description, the gist of the present disclosure is not limited thereto. The present disclosure may similarly be applied to various types of wearable devices, such as glasses, necklaces, watches, belts, and shoes.

In short, the present disclosure has been described in the form of exemplification, and the contents described in the present description should not be interpreted in a limited manner. In order to determine the gist of the present disclosure, the claims should be taken into consideration.

Note that the present disclosure can have the following configurations.

(1) A wearable device including:
a main body;
a first proximity sensor disposed on a first side surface of the main body;
a second proximity sensor disposed on a second side surface of the main body, the second side surface forming an angle equal to or larger than a predetermined angle with the first side surface; and
a determination unit that determines whether or not the main body is worn on a body of a user on the basis of a sensor signal of each of the first proximity sensor and the second proximity sensor.

(2) The wearable device according to (1) described above, in which
the first proximity sensor and the second proximity sensor include any one or a combination of two of an IR sensor, an electrostatic sensor, a body temperature sensor, and a color sensor.

(3) The wearable device according to any one of (1) and (2) described above, in which,
while the main body is worn on the body of the user, there is a case where the first side surface is separated from the body of the user, but the second side surface remains in contact with the body of the user.

(4) The wearable device according to any one of (1) to (3) described above, in which,
when the main body is worn on an ear of the user, the first side surface faces a cavum concha, and the second side surface faces an antitragus or an antihelix.

(5) The wearable device according to (4) described above, in which
the first proximity sensor includes any one of an IR sensor, a body temperature sensor, and a color sensor, and
the second proximity sensor includes an electrostatic sensor.

(6) The wearable device according to any one of (1) to (5) described above, further including
a control unit that controls the main body on the basis of a determination result by the determination unit.

(7) The wearable device according to any one of (1) to (6) described above, in which
the wearable device includes an earphone,
the first proximity sensor is disposed on a bottom surface of the main body to capture a cavum concha, and
the second proximity sensor is disposed on a side surface adjacent to the bottom surface of the main body to capture an antihelix and an antitragus.

(8) A control method of a wearable device used by being worn on a body of a user,
the wearable device including a main body, a first proximity sensor disposed on a first side surface of the main body, and a second proximity sensor disposed on a second side surface of the main body, the second side surface forming an angle equal to or larger than a predetermined angle with the first side surface,
the control method including:
a determination step of determining whether or not the main body is worn on the body of the user on the basis of a sensor signal of each of the first proximity sensor and the second proximity sensor; and
a control step of controlling the main body on the basis of a determination result in the determination step.

### REFERENCE SIGNS LIST

100 Earphone
101 Main body
102 Sound guide part
103 Earpiece
601 Control unit
602 Wireless communication unit
603 Processing unit
604 Sound output unit
700 Head mounted display
701 Main body
702 Temple
811 First proximity sensor
812 Second proximity sensor
901 Control unit
902 Communication interface unit
903 Processing unit
904 Display unit
905 Sound output unit
1000 Wearable device
1001 Sensor
1200 Wearable device
1201 First proximity sensor
1202 Second proximity sensor
1400 Wearable device
1401 First proximity sensor
1402 Second proximity sensor

What is claimed is:

1. A wearable device comprising:
a main body;
a first proximity sensor disposed on a first side surface of the main body;
a second proximity sensor disposed on a second side surface of the main body, the second side surface forming an angle equal to or larger than a predetermined angle with the first side surface; and
a determination unit that determines whether or not the main body is worn on a body of a user on a basis of a sensor signal of each of the first proximity sensor and the second proximity sensor.

2. The wearable device according to claim 1, wherein the first proximity sensor and the second proximity sensor include any one or a combination of two of an IR sensor, an electrostatic sensor, a body temperature sensor, and a color sensor.

3. The wearable device according to claim 1, wherein, while the main body is worn on the body of the user, there is a case where the first side surface is separated from the body of the user, but the second side surface remains in contact with the body of the user.

4. The wearable device according to claim 1, wherein, when the main body is worn on an ear of the user, the first side surface faces a cavum concha, and the second side surface faces an antitragus or an antihelix.

5. The wearable device according to claim 4, wherein
the first proximity sensor includes any one of an IR sensor, a body temperature sensor, and a color sensor, and
the second proximity sensor includes an electrostatic sensor.

6. The wearable device according to claim 1, further comprising
a control unit that controls the main body on a basis of a determination result by the determination unit.

7. The wearable device according to claim 1, wherein
the wearable device includes an earphone,
the first proximity sensor is disposed on a bottom surface of the main body to capture a cavum concha, and
the second proximity sensor is disposed on a side surface adjacent to the bottom surface of the main body to capture an antihelix and an antitragus.

8. A control method of a wearable device used by being worn on a body of a user,
the wearable device comprising a main body, a first proximity sensor disposed on a first side surface of the main body, and a second proximity sensor disposed on a second side surface of the main body, the second side surface forming an angle equal to or larger than a predetermined angle with the first side surface,
the control method comprising:
a determination step of determining whether or not the main body is worn on the body of the user on a basis of a sensor signal of each of the first proximity sensor and the second proximity sensor; and
a control step of controlling the main body on a basis of a determination result in the determination step.
